(19) United States
(12) Patent Application Publication
(10) Pub. No.: US 2008/0287560 A1
(43) Pub. Date: Nov. 20, 2008

(54) Polymer foams containing multi-functional layered nano-graphite

(76) Inventors: Roland R. Loh, Stow, OH (US); Mark E. Polasky, Mogadore, OH (US); Joseph P. Rynd, Tallmadge, OH (US); Yadollah Delaviz, Lewis Center, OH (US); Manoj K. Choudhary, Reynoldsburg, OH (US); Bharat Patel, Dublin, OH (US)

Correspondence Address: OWENS CORNING, 2790 COLUMBUS ROAD, GRANVILLE, OH, 43023, US

(21) Appl. No.: 11/481,130

(22) Filed: Jul. 5, 2006

Related U.S. Application Data
(63) Continuation-in-part of application No. 11/026,011, filed on Dec. 31, 2004.

(51) Int. Cl. C08J 9/228; C08F 110/00; C08F 14/06; C08G 65/38; C08G 63/00; C08G 18/00; C08G 8/00

(52) U.S. Cl. 521/79; 521/50; 521/142; 521/145; 521/189; 521/180; 521/182; 521/149; 521/155; 521/181

(57) ABSTRACT

This invention relates to foam insulating products, particularly extruded polystyrene foam, containing nano-graphite as a process additive for improving the physical properties of foam products.

### CROSS-REFERENCE TO RELATED APPLICATIONS

This application is a continuation-in-part of U.S. patent application Ser. No. 11/026,011, filed Dec. 31, 2004.

### TECHNICAL FIELD AND INDUSTRIAL APPLICABILITY OF THE INVENTION

The present invention relates to rigid foamed polymeric boards containing nano-graphite. More particularly, it relates to rigid foamed polymeric board wherein nano-graphite is added to provide benefits as a process aid, an R-value enhancer, UV radiation stability enhancer, a dimensional stability enhancer, a mechanical strength enhancer, and as a fire retardant. The added nanographite also is added to control the cell morphology, to reduce foam surface static, and to function as internal lubricant in the foaming process.

### BACKGROUND OF THE INVENTION

The usefulness of rigid foamed polymeric boards in a variety of applications is well known. For instance, polymeric foam boards are widely used as isulating structural members in buildings.

In the past, infrared attenuating agents (IAAs) such as carbon black powdered amorphous carbon, graphite, and titanium dioxide have been used as fillers in polymeric foam boards to minimize material thermal conductivity which, in turn, will maximize insulating capability (increase R-value) for a given thickness. R value is defined as the commercial unit used to measure the effectiveness of thermal insulation. A thermal insulator is a material, manufactured in sheets, that resists conducting heat energy. Its thermal conductance is measured, in traditional units, in Btu's of energy conducted times inches of thickness per hour of time per square foot of area per Fahrenheit degree of temperature difference between the two sides of the material. The R value of the insulator is defined to be 1 divided by the thermal conductance per inch. R is an abbreviation for the complex unit combination hr·ft²·° F./Btu. In SI units, an R value of 1 equals 0.17611 square meter Kelvin per watt (m²·K/W).

The heat transfer through an insulating material can occur through solid conductivity, gas conductivity, radiation, and convection. The total thermal resistance (R-value), R is the measure of the resistance to heat transfer, and is determined as: R=t/k, where, t=thickness.

Rigid foamed plastic boards are extensively used as thermal insulating materials for many applications. It is highly desirable to improve the thermal conductivity without increasing the density, and/or the thickness of foam product. Particularly, the architectural community desires a foam board having a thermal resistance value of R=10, with a thickness of less than 1.8″, for cavity wall construction, to keep at least 1″ of the cavity gap clean.

It is also desirable to improve the UV stability, particularly for such as exterior wall insulation finishing system (EIFS), and highway and railway underground applications where prolonged exposure of sun light of the surface of the polymer foam boards are usually occurred in job-sites.

Regular low density foams have very thin cell wall thickness in the range of 0.2 to 6 microns. Particularly, in order to enhance the insulation R-value, a target cell wall thickness of less than about 1 micron is needed.

Thus, there is a need to graphite having at least in one dimension—usually the thickness of the plate shaped graphite in nano-scale, i.e., less than 0.1 microns or 100 nanometers. It is an object of the present invention to provide a process for preparing low density extruded polymer foams containing nano-graphite which has good processing properties, and improved foam physical properties, including thermal conductivity, ultraviolet (UV) radiation resistance, dimensional stability, mechanical strength, flame spread rate and smoke density.

### SUMMARY OF THE INVENTION

The present invention relates to foam insulating products and the processes for making such products, such as extruded polystyrene foam, containing nano-graphite as a process additive to improve the physical properties, such as thermal insulation and compressive strength. During foaming, nano-graphite acts as a nucleating agent and lubricant as well as its slipping action makes the flow of the melted polymer in the extruder easier, and provides a smooth surface to the foam board. Further, the nano-graphite reduces the amount of static present during the foaming process due to the increased electric conductivity of the skin of the nano-graphite polymer foam boards. Nano-graphite in a foam product also acts as a UV stabilizer and as a gas barrier in the final product.

It is an object of the present invention to produce a rigid polymer foam containing nano-graphite which exhibits overall compound effects on foam properties including improved insulating value (increased R-value) for a given thickness and density, and ultraviolet (UV) stability.

It is another object of the present invention to produce a rigid polymer foam containing nano-graphite having retained or improved compressive strength, thermal dimensional stability and fire resistance properties.

It is another object of the present invention to provide nano-graphite in a rigid polymer foam which also acts as a process additive which control the cell morphology, reduces static and provides lubrication during the foaming process.

It is another object of the present invention to lower the cost of a polymeric foam product in a simple and economical manner, such as by using nano-graphite as a low cost, functional colorant.

The foregoing and other advantages of the invention will become apparent from the following disclosure in which one or more preferred embodiments of the invention are described in detail and illustrated in the accompanying drawings. It is contemplated that variations in procedures, structural features and arrangement of parts may appear to a person skilled in the art without departing from the scope of or sacrificing any of the advantages of the invention.

### BRIEF DESCRIPTION OF DRAWINGS

FIG. 1 is a graphical illustration depicting the density v. compressive modulus of polystyrene foam and polystyrene foams containing nano-graphite.

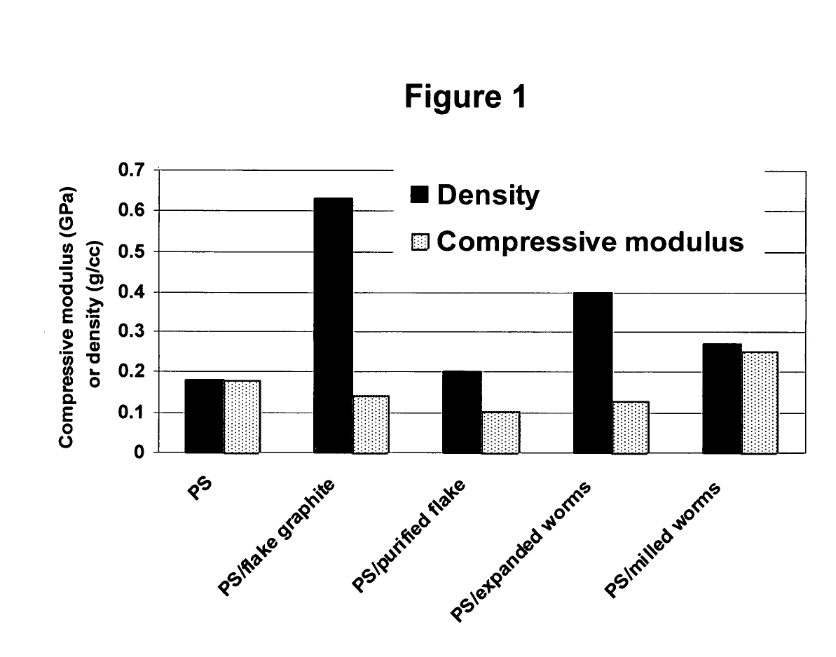

FIG. 2 is a graphical illustration comparing the rheology of pure polystyrene foam v. polystyrene foam containing nanographite.

FIG. 3 is a scanning electronic microscope (SEM) image of the foam cells of the present invention.

FIG. 4 is a scanning electronic microscope (SEM) image of the foam cell walls and struts.

FIG. 5 is a graphical illustration comparing a polystyrene foam board to the nano-graphite/polystyrene board of the present invention when both boards are exposed to UV radiation.

### DETAILED DESCRIPTION OF INVENTION

The above objects have been achieved through the development of a polymer foam which contains nano-graphite to control cell morphology and act as a gas diffusion barrier. The foam exhibits improved thermal insulation (R-values) acting as an infrared attenuating agent and a cell nucleating agent. The nano-graphite in the foam serves as an internal lubricant during processing of the foam and permits the release of surface static during processing of the foam. Foams containing nano-graphite, of the present invention, also have increased dimensional stability. Aesthetically, the foam of the present invention has a shiny surface and is silver in color.

The present invention particularly relates to the production of a rigid, closed cell, polymer foam board prepared by extruding process with nano-graphite, at least one blowing agent and other additives.

The rigid foamed plastic materials may be any such materials suitable to make polymer foams, which include polyolefins, polyvinylchloride, polycarbonates, polyetherimides, polyamides, polyesters, polyvinylidene chloride, polymethylmethacrylate, polyurethanes, polyurea, phenol-formaldehyde, polyisocyanurates, phenolics, copolymers and terpolymers of the foregoing, thermoplastic polymer blends, rubber modified polymers, and the like. Suitable polyolefins include polyethylene and polypropylene, and ethylene copolymers.

A preferred thermoplastic polymer comprises an alkenyl aromatic polymer material. Suitable alkenyl aromatic polymer materials include alkenyl aromatic homopolymers and copolymers of alkenyl aromatic compounds and copolymerizable ethylenically unsaturated comonomers. The alkenyl aromatic polymer material may further include minor proportions of non-alkenyl aromatic polymers. The alkenyl aromatic polymer material may be comprised solely of one or more alkenyl aromatic homopolymers, one or more alkenyl aromatic copolymers, a blend of one or more of each of alkenyl aromatic homopolymers and copolymers, or blends of any of the foregoing with a non-alkenyl aromatic polymer.

Suitable alkenyl aromatic polymers include those derived from alkenyl aromatic compounds such as styrene, alphamethylstyrene, ethylstyrene, vinyl benzene, vinyl toluene, chlorostyrene, and bromostyrene. A preferred alkenyl aromatic polymer is polystyrene. Minor amounts of monoethylenically unsaturated compounds such as C₂₋₆ alkyl acids and esters, ionomeric derivatives, and C₄₋₆ dienes may be copolymerized with alkenyl aromatic compounds. Examples of copolymerizable compounds include acrylic acid, methacrylic acid, ethacrylic acid, maleic acid, itaconic acid, acrylonitrile, maleic anhydride, methyl acrylate, ethyl acrylate, isobutyl acrylate, n-butyl acrylate, methyl methacrylate, vinyl acetate and butadiene

Preferred structures comprise substantially (i.e., greater than about 95 percent) and most preferably entirely of polystyrene. The present invention relates to a process for preparing a foam product involving the steps of forming a foamable mixture of (1) polymers having weight-average molecular weights from about 30,000 to about 500,000. In one embodiment, the polystyrene has weight-average molecular weight about 250,000, and (2) nano-graphite, (3) at least one blowing agent, (4) other process additives, such as a nucleation agent, flame retardant chemicals, foaming the mixture in a region of atmosphere or reduced pressure to form the foam product.

The nano-graphite used in this invention is a nano-graphite which has at least in one dimension, most likely the thickness of the particle, less than about 100 nanometers by X-ray diffraction. The foam comprises nanosheets of exfoliated graphite dispersed in the polymeric matrix. Exfoliated graphite is graphite that has been intercalated preferably by an oxidation process, where the atoms or molecules have been inserted into the inter-planar spacing between the layered planes of carbons, and expanded. The intercalated graphite is expanded or exfoliated preferably by brief exposure to high heat to expand the thickness of the graphite. The expanded or exfoliated graphite is then mixed with monomers and polymerized in situ to form a polymer with a network of nanosheets of the exfoliated graphite dispersed therein.

The exfoliated graphite advantageously retains its nanostructure during the polymerization process. The expanded or exfoliated graphite is compressed together into flexible thin sheets. The nano-graphite in the foam comprises a plurality of nanosheets typically in layers. The nanosheets having a thickness of between about 10 to several hundred nanometers, with majority in the range from about 10 to about 100 nanometers. Detailed explanation of graphite exfoliation may be found in Graphite Intercalation Compounds I: Structure and Dynamics, H. Zabel; S. A. Solin (1990) and Carbon and Graphite Handbook, C. L. Mantell (1968) which are herein incorporated by reference.

Standard extrusion processes and methods which may be used in the process of manufacturing the invention are described in commonly owned U.S. Pat. No. 5,753,161 which is herein incorporated by reference in its entirety. Detailed descriptions of foaming methods, including expansion and extrusion can be found in Plastics Processing Data Handbook (2nd Edition), Rosato, Dominick™ 1997 Springer—Verlag which is herein incorporated by reference.

In the extrusion process, an extruded polystyrene polymer, nano-graphite foam is prepared by twin-screw extruders (low shear) with flat die and plate shaper. Alternatively, a single screw tandem extruder (high shear) with radial die and slinky shaper can be used. Nano-graphite is then added into the extruder preferably greater than 0% to about 10%, more preferably about 0.5 to about 3% by weight based on the weight of the polymer along with polystyrene, a blowing agent, and optionally other additives. In a preferred embodiment, an extruded polystyrene polymer foam is prepared by twin-screw extruders (low shear) with flat die and plate shaper. Alternatively, a single screw tandem extruder (high shear) with radial die and slinky shaper can be used. Preferably, the nano-graphite compound is added into the extruder via multi-feeders, along with polystyrene, a blowing agent, and/or other additives.

The plasticized resin mixture, containing nano-graphite, polymer, and optionally, other additives are heated to the melt mixing temperature and thoroughly mixed. The melt mixing temperature must be sufficient to plastify or melt the polymer. Therefore, the melt mixing temperature is at or above the glass transition temperature or melting point of the polymer. Preferably, in the preferred embodiment, the melt mix temperature is from about 200 to about 250° C., most preferably about 220 to about 240° C. depending on the amount of nano-graphite.

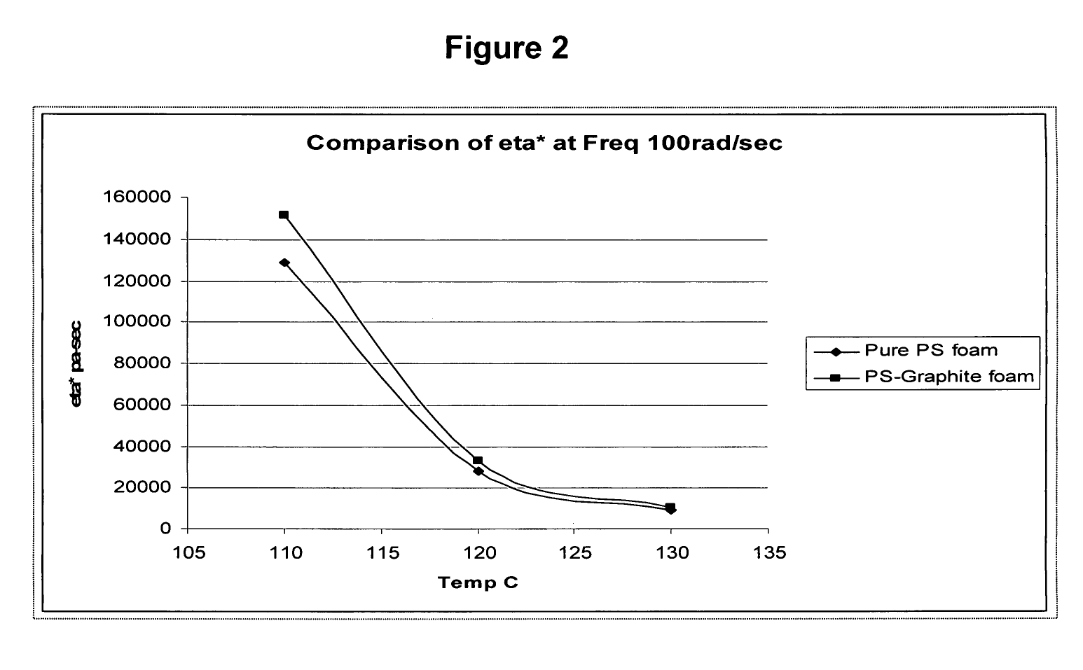

A blowing agent is then incorporated to form a foamable gel. The foamable gel is then cooled to a die melt temperature. The die melt temperature is typically cooler than the melt mix temperature, in the preferred embodiment, from about 100° C. to about 130° C., and most preferably from about 120° C. The die pressure must be sufficient to prevent prefoaming of the foamable gel, which contains the blowing agent. Prefoaming involves the undesirable premature foaming of the foamable gel before extrusion into a region of reduced pressure. Accordingly, the die pressure varies depending upon the identity and amount of blowing agent in the foamable gel. Preferably, in the preferred embodiment, the pressure is from about 50 to about 80 bars, most preferably about 60 bars. The expansion ratio, foam thickness per die gap, is in the range of about 20 to about 70, typically about 60. FIG. 2 illustrates a comparison of viscosity (eta*in Pa-sec) between grade 1600 polystyrene from NOVA Chemical, PA and the same polystyrene with 1 wt % of nano-graphite additive at regular die shear rate range (around 100 rad/sec frequency). In the regular die temperature operation range—from 115 to 125° C., the viscosity of the polystyrene with nano-graphite is higher, but is manageable within the operation temperature window.

Any suitable blowing agent and combinations of blowing agents may be used in the practice on this invention. Blowing agents useful in the practice of this invention include inorganic agents, organic blowing agents and chemical blowing agents. Suitable inorganic blowing agents include carbon dioxide, nitrogen, argon, water, air, nitrogen, and helium. Organic blowing agents include aliphatic hydrocarbons having 1-9 carbon atoms, aliphatic alcohols having 1-3 carbon atoms, and fully and partially halogenated aliphatic hydrocarbons having 1-4 carbon atoms. Aliphatic hydrocarbons include methane, ethane, propane, n-butane, isobutane, n-pentane, isopentane, and neopentane. Aliphatic alcohols include methanol, ethanol, n-propanol, and isopropanol. Fully and partially halogenated aliphatic hydrocarbons include fluorocarbons, chlorocarbons, chlorofluorocarbons and cyclopentane. Examples of fluorocarbons include methyl fluoride, perfluoromethane, ethyl fluoride (HFC-161), ethyl fluoride, 1,1-difluoroethane (HFC-152a), 1,1,1-trifluoroethane (HFC-143a), 1,1,1,2-tetrafluoro-ethane (HFC-134a), 1,1,2,2-tetrafluoroethane (HFC-134), pentafluoroethane (HFC-125), difluoromethane (HFC-32), perfluoroethane, 2,2-difluoropropane (HFC-272fb), 1,1,1-trifluoropropane (HFC-263fb), perfluoropropane, 1,1,1,3,3-pentafluorobutane (HFC-365mfc), 1,1,1,3,3-pentafluoropropane (HFC 245fa), 1,1,1,2,3,3,3-heptafluoropropane (HFC-227ea), dichloropropane, difluoropropane, perfluorobutane, and perfluorocyclobutane. Partially halogenated chlorocarbons and chlorofluorocarbons for use in this invention include methyl chloride, methylene chloride, ethyl chloride, 1,1,1-trichloroethane, 1,1-dichloro-1-fluoroethane(HCFC-141b), 1-chloro-1,1-difluoroethane (HCFC-142b), 1,2-difluoroethane (HFC-142), chlorodifluoromethane (HCFC-22), 1,1-dichloro-2,2,2-trifluoroethane (HCFC-123) and 1-chloro-1,2,2,2-tetrafluoroethane (HCFC-124), and the like. Fully halogenated chlorofluorocarbons include trichloromonofluormethane (CFC-11), dichlorodifluoromethane (CFC-12), trichlorotrifluoroethane (CFC-113), 1,1,1-trifluoroethane, pentafluoroethane, dichlorotetrafluoroethane (CFC-114), chloroheptafluoropropane, and dichlorohexafluoropropane. Chemical blowing agents include azodicarbonamide, azodiisobutyro-nitrile, benzenesulfonhydrazide, 4,4-oxybenzene sulfonyl-semicarbazide, p-toluene sulfonyl semi-carbazide, barium azodicarboxylate, and N,N′-dimethyl-N,N′-dinitrosoterephthalamide and trihydrazino triazine.

A mixture of blowing agents may be used with the present invention such as a mixture including 1,1,2,2-tetrafluoroethane (HFC-134a) with around same amount of 1,1-difluoroethane (HFC-152a). About 50% of the 134a blowing agent and about 50% of the 152b blowing agent may be present in the composition. Both components based on the weight of the polymer. However, for low density, thick products, the amount of 152a may be increased up to about 60% or more based on the weight of the polymer.

In the present invention it is preferable to use about 6 to about 14%, preferably about 11%, cyclopentane by weight based on the weight of the polymer. It is preferred to add about 0 to about 4% ethanol, about 3 to about 6%, preferably about 3.5% carbon dioxide. All percentages are based on the weight of the polymer.

Optional additives may be incorporated in the extruded foam product and include additional infrared attenuating agents, plasticizers, flame retardant chemicals, pigments, elastomers, extrusion aids, antioxidants, fillers, antistatic agents, UV absorbers, citric acids, nucleating agents, surfactants, processing aids, etc. These optional additives may be included in any amount to obtain desired characteristics of the foamable gel or resultant extruded foam products. Preferably, optional additives are added to the resin mixture but may be added in alternative ways to the extruded foam manufacture process.

The product produced by the above-described process is a rigid, foam insulation board which is about ⅛ to about 12 inches thick, typically about 1 to about 4 inches thick. The density of the foam board is typically about 1.2 to about 5 pcf, typically about 1.4 to about 3 pcf. The resulting board is silver in color with a shiny surface.

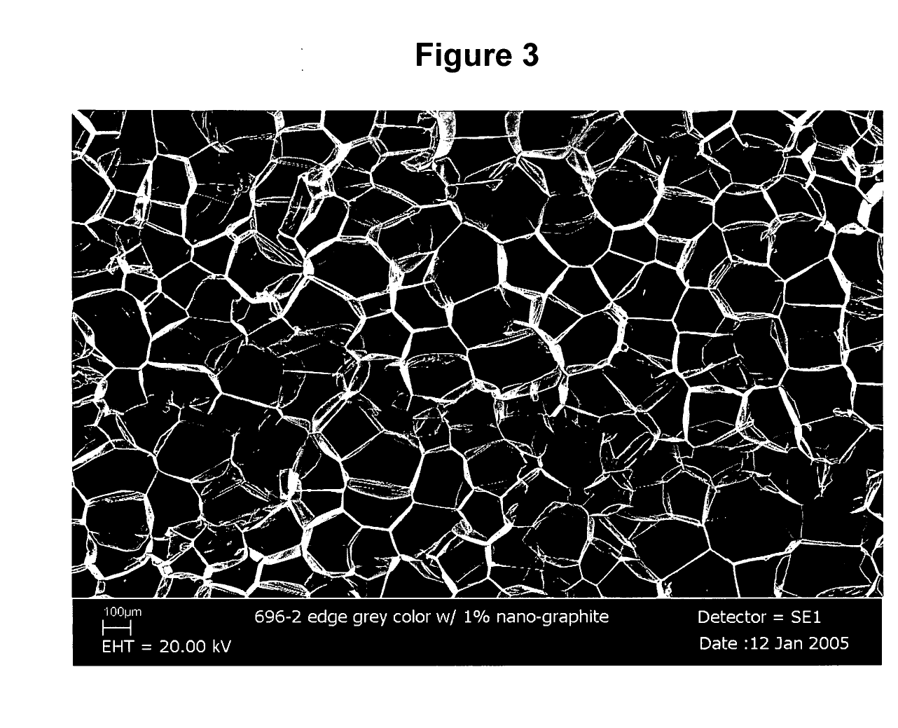

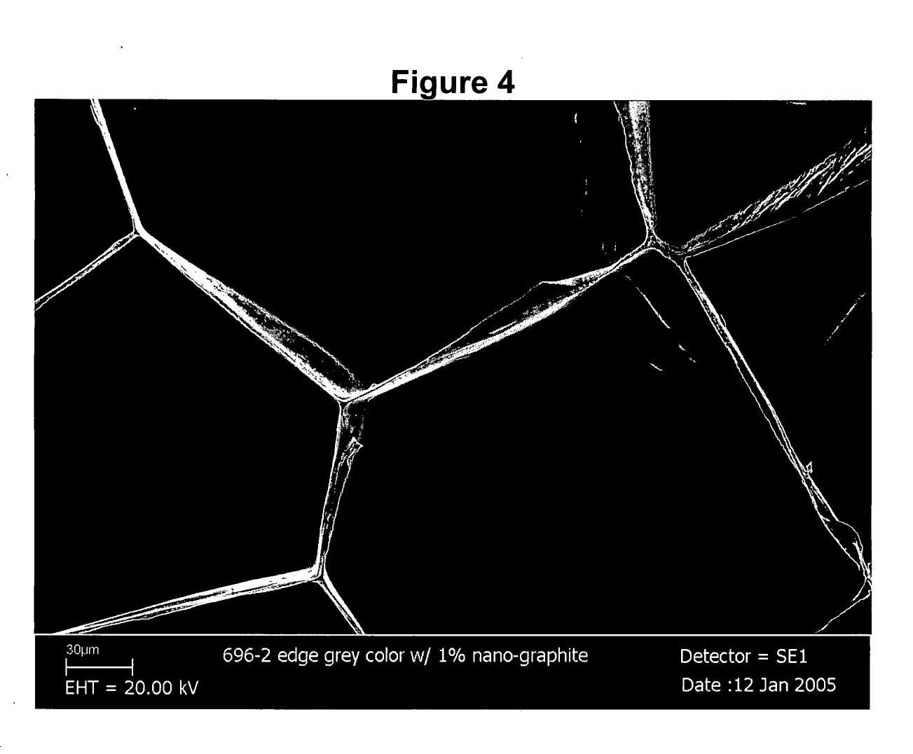

As mentioned above, the nanographite in the foam controls cell morphology. The nano-scale graphite acts as a nucleating agent in the foaming process FIG. 3 is an SEM image of the foam including 1% nano-graphite in polystyrene foam. The average cell size of the foam without any other nucleating agent such as talc is around 220 microns; orientation in the x/z direction=1.26 (×0.254, y 0.205, z 0.201 mm). FIG. 4 is an SEM image of the cell walls and struts of the foam product. The polystyrene foam contains 1% nano-graphite. The thickness of the cell walls is about 0.86 microns, the strut diameter is about 3.7 microns.

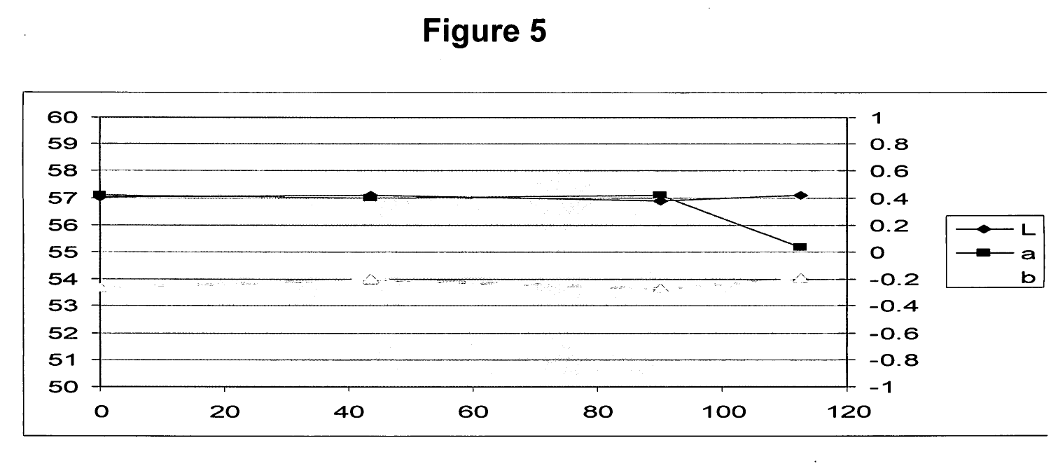

FIG. 5 illustrates the UV protect ability of polystyrene foam board with the nano-graphite of the present invention when the board is exposed to UV radiation. The test method used is a QUV test, followed by color measurement. Test methods and material standards for the QUV test include ISO 4982-1 Plastics, ASTM G-151, ASTM G-154, ASTM G53, British Standard BS 2782, Part 5, Method 540B, and SAE J2020, JIS D0205. All test methods and standards cited above are herein incorporated by reference. The color measurements are made on the L*a*b scales. The L scale, from 0 to 100, represents a black to white relationship. The nano-graphite foam with grey color was almost no change from an extended UV exposure for more than 100 days. The a and b scale, from 1 to −1, represent the different color changes: from red to green, and from yellow to blue. Slight changing of color has been observed after more than 90 days UV exposure for the nano-graphite foam board.

Having generally described this invention, a further understanding can be obtained by reference to certain specific examples illustrated below which are provided for purposes of illustration only and are not intended to be all inclusive or limiting unless otherwise specified.

### EXAMPLE 1

The invention is further illustrated by the following Example 1, which is not to be construed as limiting, in which all foam boards are extruded polystyrene foam boards. In the following samples and control samples, rigid polystyrene foam boards are prepared by a twin screw LMP extruder with flat die and shaper plate; and a two single screw tandem extruder with radial die and slinky shaper. A vacuum may also be applied in both of the above described pilot and manufacturing lines.

Table 1 shows the process conditions for samples in a twin screw extruder for making foam boards having a width of 16 inches and a thickness of one inch.

TABLE 1
Process Conditions of Samples

| | Samples on Table 4 |
|---|---|
| Wt. % of nano-graphite | 1 to 5 |
| Wt. % of talc | 0.5-1.5 |
| Wt. % of nano-carbon black | 0 to 6 |
| Wt. % of mica | 0 to 4 |
| Wt. % of HCFC-142b | 11 |
| Wt. % of CO₂ | 0 |
| Extruder Pressure, Kpa (psi) | 13000-17000 |
| | (1950-2400) |
| Die Melt Temperature, (° C.) | 117-123 |
| Die Pressure, Kpa (psi) | 5400-6600 |
| | (790-950) |
| Line Speed, m/hr (ft/min) | 110-170 |
| | (6-9.5) |
| Throughput, kg/hr | 100 |
| Die Gap, mm | 0.6-0.8 |
| Vacuum KPa (inch Hg) | 0-3.4 |
| | (0 to 16) |

The thickness of nano-graphite used was confirmed by X-ray diffraction to be 29.7 nm, and 51 nm after compounding with about 60 wt % of polystyrene. Carbon black was not part of mix with nano-graphite due to its poor process ability and high smoke density during fire test.

The results of above examples are shown in Table 2. All R-values and compressive strength are tested after the samples aged for 180 days.

TABLE 2

| | Aged R-value | Density | Compressive | Nano- |
|---|---|---|---|---|
| | K · m2/K | Kg/m3 | Strength | graphite |
| Run # | (F · ft2 · hr/Btu) | (pcf) | psi | Wt % |
| Control | 0.029 | 27.68 | NA | 0 |
| sample | (5.05) | (1.73) | | |
| 696-2 | 0.025 | 28.64 | 21.55 | 1 |
| X8234 | (5.82) | (1.79) | | |
| 696-4 | 0.024 | 30.72 | 22.67 | 3 |
| X8235 | (6.03) | (1.92) | | |
| 692-2 | 0.025 | 27.84 | 25.69 | 1 |
| X8207 | (5.77) | (1.74) | | |
| 692-3 | 0.024 | 28.8 | 27.27 | 2 |
| X8208 | (5.94) | (1.80) | | |
| 692-4 | 0.024 | 28.96 | 26.87 | 3 |
| X8209 | (6.00) | (1.81) | | |

As shown from above samples, the addition of nano-graphite in foaming processing, preferably about 1% to about 3% by the weight of the solid foam polymer has profound effect on the thermal resistance property. The range of the R-value was determined to be between about 5.7 and about 6.0.

### EXAMPLE 2

Table 3 compares the operating conditions between batch foaming and traditional low-density foam extrusion.

TABLE 3
Comparison of Operating Conditions
between Batch and Extrusion Foaming

| Operating conditions | Extrusion | Batch Foaming |
|---|---|---|
| Temperature (° C.) | 100~140 | 120 |
| Pressure (psi) | 1000~2000 | 2000 |
| dP/dt (Pa/sec) | 10⁶ | 10⁶ |

Prior to batch foaming, the polymerized nano-graphite/polystyrene compound is heated and compressed into a solid shape. The solid sheet is cut into small pieces according to the size of pressure vessel, such as 77×32×1 mm. The solid sheet specimen is then placed in a mold and foamed in a high-pressure vessel at about 80 to about 160° C., typically about 120° C. and about 500 to about 4000 psi, typically about 2000 psi. The solid sheet remains in the pressurized vessel for about 8 to about 50 hours, typically about 12 hours, after which the pressure in the vessel was released quickly (about 12 seconds) for foaming.

The nano-graphite/polystyrene foam of the batch foaming samples were evaluated to determine the amount infrared radiation transmitted through the foam. As infrared light is the major form of thermal radiation.

A piece of batch-foamed sample containing polystyrene and 3% graphite, and two other comparison samples containing polystyrene or polystyrene and 5% nano-clay were selected. On one side of the foam sample a light source of infrared laser was placed. On the other side of the sample, either a detector was placed to record the transmission light intensity or a temperature camera was placed to monitor the surface temperature change. The results are summarized in Table 4.

TABLE 4
Infrared Light Transmission Through foam samples of polystyrene
(PS), polystyrene and 5% nano-clay (PS/5% clay), and polystyrene
and 3% nano-graphite (PS/3% graphite)

| IR Transmission Intensity | Emissive | Received | |
|---|---|---|---|
| (watts) | Intensity | Intensity | % Trans |
| PS (control sample) | 0.5 | 0.05 | 10% |
| PS/5% MHABS* | 0.5 | 0.02 | 4% |
| PS/3% milled graphite worms | 0.5 | 0.01 | 2% |

*in-situ polymerized compound with 5% of reactive cationic surfactant, 2-methacryloyloxyethylhexadecyldimethyl ammonium bromide (MHAB) treated Na+ montmorillonite with 95% styrene monomer

As shown in Table 4, 10% of the light transmits through the pure PS foam sample, while only 4% through the PS/5% clay foam sample and only 2% through the PS/3% graphite sample. Both clay and graphite have the attenuation effect on the infrared light, however, as shown in the above table, PS/3% graphite has considerably better transmission attenuation.

The temperature of the PS/graphite sample, on the side of the sample opposite to the light source, was slightly elevated, having an increase of about 2-3° F. after 60 seconds of exposure (Table 5). There was no obvious change in surface temperature for foam samples of pure PS (control sample) and PS with MHABS nano-clay. As such, PS/graphite foam attenuates thermal radiation and enhances the heat solid conduction. Further, by improved graphite dispersion and concentration, these trends are expected to be more significant.

TABLE 5
Temperature change for foam samples of PS, PS/5% clay, and
PS/3% graphite on the surface opposite to the light source

| | IR Camera Temperature at Interval Time in Seconds ° F. | | | | | | |
|---|---|---|---|---|---|---|---|
| | 0 | 10 | 20 | 30 | 40 | 50 | 60 |
| PS (control sample) | 78.4° F. | 78.4° F. | 78.7° F. | 78.8° F. | 78.4° F. | 78.5° F. | 78.5° F. |
| PS/5% MHABS | 79.2° F. | 79.2° F. | 79.5° F. | 79.6° F. | 79.4° F. | 79.5° F. | 79.6° F. |
| PS/3% milled graphite worms | 80.6° F. | 81.2° F. | 81.7° F. | 82° F. | 82.6° F. | 82.8° F. | 83° F. |

The foregoing description of the specific embodiments will so fully reveal the general nature of the invention that others can, by applying knowledge within the skill of the art (including the contents of the references cited herein), readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one of ordinary skill in the art.

The invention of this application has been described above both generically and with regard to specific embodiments. Although the invention has been set forth in what is believed to be the preferred embodiments, a wide variety of alternatives known to those of skill in the art can be selected within the generic disclosure. The invention is not otherwise limited, except for the recitation of the claims set forth below.

1. A polymeric foam material comprising:
a) a polymer;
b) at least one blowing agent; and
c) nano-graphite.

2. The polymeric foam material of claim 1, wherein the nano-graphite is present in an amount greater than 0% to about 10% by weight based on the polymer.

3. The polymeric foam material of claim 1, wherein the blowing agents comprise a mixture of 1,1,2,2-tetrafluoroethane (HFC-134), 1,1-difluoroethane (HFC-152a) and 1,2-difluoroethane (HFC-142).

4. The polymeric foam material of claim 1, further comprising one or more additives selected from the group of cell size enlarge agents, infrared attenuating agents, plasticizers, flame retardant chemicals, pigments, elastomers, extrusion aids, antioxidants fillers, antistatic agents and UV absorbers.

5. The polymeric foam material of claim 1, wherein said nano-graphite further comprises a plurality of nanosheets.

6. The polymeric foam material of claim 5, wherein said plurality of nanosheets have a thickness of between about 10 to several hundred nanometers, with majority in the range from about 10 to about 100 nanometers.

7. The polymeric foam material of claim 6, wherein said plurality of nanosheets comprises a plurality of single carbon layers of graphite.

9. The polymeric foam material of claim 1, wherein the R-value of said material is between about 3 to about 8.

10. The polymeric foam material of claim 1, wherein the polymer is selected from the group of polyolefins, polyvinylchloride, polycarbonates, polyetherimides, polyamides, polyesters, polyvinylidene chloride, polymethylmethacrylate, polyurethanes, polyurea, phenol-formaldehyde, polyisocyanurates, phenolics, copolymers and terpolymers of the foregoing, thermoplastic polymer blends and rubber modified polymers.

11. A method for making an extruded polymer foam comprising the steps of:
a) mixing a resin mixture comprising a polymer and nano-graphite compound;
b) heating said resin mixture to a melt mixing temperature;
c) incorporating one or more blowing agents into the resin mixture under a pressure sufficient to prevent pre-foaming of the gel;
d) cooling the gel to a die melt temperature; and
e) extruding the gel through a die to a region of lower die pressure to form the foam.

12. The method of claim 11, wherein the nano-graphite compound is added in an amount of greater than 0% to about 100% by weight based on the polymer.

13. The method of claim 12, wherein the blowing agents comprise a mixture of 1,1,2,2-tetrafluoroethane (HFC-134), 1,1-difluoroethane (HFC-152a) and 1,2-difluoroethane (HFC-142).

14. The method of claim 11, further comprising the step of mixing one or more additives selected from the group consisting of cell size enlarge agents, infrared attenuating agents, plasticizers, flame retardant chemicals, pigments, elastomers, extrusion aids, antioxidants fillers, antistatic agents and UV absorbers into the mixture

15. The method of claim 11, wherein the polymer is polystyrene.

16. A method for making a batch polymer foam comprising the steps of:
a) adding extruded or molded polymer solid containing nano-graphite to a pressure vessel;
b) adding at least one blowing agent to the pressure vessel;
c) pressurizing said pressure vessel to a level sufficient to force an appropriate amount of the blowing agent into the free volume of the polymer.
d) reducing the pressure and removing said roll of polymer containing nano-graphite from the pressure vessel when the blowing agent has thoroughly saturated the polymer.

17. A rigid foam insulation board comprising:
a) a polymer;
b) at least one blowing agent; and
c) nano-graphite.

18. The insulation board of claim 17, wherein the R-value of said board is between about 3 to about 8.

19. The insulation board of claim 17, wherein said insulation board has a thickness of between about ⅛ inch to about 10 inches.

20. The insulation board of claim 19, wherein the nano-graphite is present in an amount greater than 0% to about 10% by weight based on the polymer.
